(19) United States
(12) Patent Application Publication
(10) Pub. No.: US 2021/0246771 A1
(43) Pub. Date: Aug. 12, 2021

(54) SIMULTANEOUS OPERATION OF DUAL ELECTRIC SUBMERSIBLE PUMPS USING SINGLE POWER CABLE

(71) Applicant: SAUDI ARABIAN OIL COMPANY, Dhahran (SA)

(72) Inventors: Chidirim Enoch Ejim, Dhahran (SA); Rafael Adolfo Lastra Melo, Dhahran (SA)

(73) Assignee: SAUDI ARABIAN OIL COMPANY, Dhahran (SA)

(21) Appl. No.: 16/784,707

(22) Filed: Feb. 7, 2020

(51) Int. Cl. E21B 43/12; E21B 47/12

(52) U.S. Cl. CPC E21B 43/128; E21B 47/12

(57) ABSTRACT

A pumping system for pumping downhole fluid is disclosed. The pumping system includes: a first electric submersible pump (ESP) and a second ESP, each of the first ESP and the second ESP including a motor, a pump inlet, and a pump outlet; a tubing fluidly coupled to the pump outlet of the first ESP and the pump outlet of the second ESP; a connector coupled to the first ESP; an electric cable coupled between an uphole power source and the connector to deliver electric power to the motor of the first ESP; and an electric cable extension coupled between the connector and the second ESP to deliver electric power to the motor of the second ESP. The first ESP and the second ESP are fluidly coupled to the tubing in parallel or in series.

### BACKGROUND

In the oil and gas industry, Electric Submersible Pumps (ESPs) are widely used for extracting underground gas and liquid. More specifically, configurations with dual ESPs are common practice, especially when flows rates from a well need to be increased or additional pressure boost is required. Configurations with dual ESPs are also common when some level of redundancy is required. To operate these ESPs simultaneously, each ESP is connected to its own dedicated electric cable which separately delivers power from a power source on the surface to the downhole ESP. At the surface, the power cables are connected to their own Variable Frequency Drives (VFDs) to control each ESP independently.

An ESP system generally includes, among other elements, a centrifugal pump, a protector, an electric cable, a motor, and a sensor such as a monitoring sub/tool. The pump is used to lift well-fluids to the surface or, if at surface, transfer fluid from one location to another. The motor provides the mechanical power required to drive the pump via a shaft. The electric cable provides a means of supplying the motor with the needed electrical power from the surface. The protector absorbs the thrust load from the pump, transmits power from the motor to the pump, equalizes pressure, provides and receives additional motor oil as temperature changes and prevents well-fluid from entering the motor. The pump consists of stages, which are made up of impellers and diffusers. The impeller, which is rotating, adds energy to the fluid to provide kinetic energy, whereas the diffuser, which is stationary, converts the kinetic energy of fluid from the impeller into pressure head. The pump stages are typically stacked in series to form a multi-stage system that is contained within a pump housing. The sum of head generated by each individual stage is summative; hence, the total head developed by the multi-stage system increases linearly from the first to the last stage. The monitoring sub/tool is installed onto the motor to measure parameters such as pump intake and discharge pressures, motor oil and winding temperature, and vibration. Measured downhole data is communicated to the surface via the electric cable.

Dual ESP configurations are common in production operations. Such systems tend to be used when some redundancy is required to operate each ESP separately. The overall economic objective is to reduce the cost of working over a well. This is typically the case for offshore operations or in locations, where the cost of workover is extremely high. In the event that one ESP fails, the other can still be operated to ensure production continues.

### SUMMARY OF INVENTION

The present disclosure relates to a pumping system for pumping downhole fluid.

The pumping system includes: a first electric submersible pump (ESP) and a second ESP, each of the first ESP and the second ESP including a motor, a pump inlet, and a pump outlet; a tubing fluidly coupled to the pump outlet of the first ESP and the pump outlet of the second ESP; a connector coupled to the first ESP; an electric cable coupled between an uphole power source and the connector to deliver electric power to the motor of the first ESP; and an electric cable extension coupled between the connector and the second ESP to deliver electric power to the motor of the second ESP.

In one aspect, the first ESP and the second ESP are fluidly coupled to the tubing in parallel such that the downhole fluid independently enters and exits the first ESP and the second ESP.

In another aspect, the first ESP and the second ESP are fluidly coupled to the tubing in series such that the pump outlet of the second ESP is in fluid communication with the pump inlet of the first ESP.

Other aspects and advantages of the invention will be apparent from the following description and the appended claims.

### BRIEF DESCRIPTION OF DRAWINGS

FIG. 1 shows a pumping system with dual ESPs arranged in parallel according to one or more embodiments.

FIGS. 2A-2C each show a pumping system with dual ESPs arranged in series according to one or more embodiments.

FIGS. 3A-3B each show a cross section of an electric cable extension according to one or more embodiments.

FIGS. 4A-4B each show a connector according to one or more embodiments.

FIG. 5 shows a block diagram of a delay starter coupled to a connector according to one or more embodiments.

### DETAILED DESCRIPTION

Specific embodiments of the present disclosure will now be described in detail with reference to the accompanying figures. Like elements in the various figures are denoted by like reference numerals for consistency. Like elements may not be labeled in all figures for the sake of simplicity.

Numerous specific details are set forth in the following detailed description in order to provide a more thorough understanding of the embodiments of the present disclosure. However, it will be apparent to one of ordinary skill in the art that the present disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

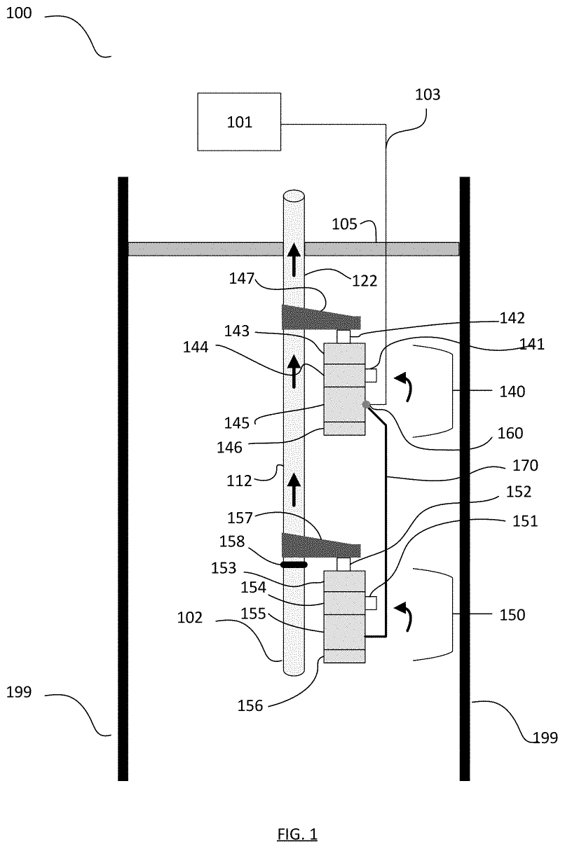

In the following description of FIGS. 1-5, any component described with regard to a figure, in various embodiments, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a horizontal beam” includes reference to one or more of such beams.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Although multiple dependent claims are not introduced, it would be apparent to one of ordinary skill that the subject matter of the dependent claims of one or more embodiments may be combined with other dependent claims.

In conventional configurations where each ESP is driven by its own cable separately and the ESPs are operated simultaneously, additional design considerations may be contemplated to provide the required production or pressure boost. One consideration is the material/equipment quantity and associated cost as a result of running two reels of cable from the surface to the ESPs downhole. Such costs can be significantly higher, especially when the ESPs are set very deep in the well. Other operational problems related to running two cables in the casing may be experienced in slimmer casings, where clearance issues are prominent. These clearance issues can result in cables getting damaged when running in hole during the ESP installation process. With two power cables from the surface to operate both ESPs, two Variable Frequency Drives (VFDs) are required to provide the required speed control to operate the upper and lower ESPs. This results in having a larger surface footprint dedicated to running the ESPs, which can be a challenge for example in offshore operations, where space is a premium.

Further, because the two power cables have to pass through the packer, a cable splice may be needed above and below the packer to ensure proper termination of the power cables for electrical continuity. Increasing the number of splices increases the potential for electrical failure. This is especially the case in wells with corrosive gases such as H25 and for splice locations below the packer. The corrosive gas tends to accumulate just below the packer and, due to the high concentration of the gas in this region, the electrical splices are highly susceptible to attack by the gas. This can lead to gas ingress and potential failure of the ESP system. The above limitations show that a more economical method of operation is needed to ensure the shortcomings of current practices are prevented or at least, mitigated, to provide benefit to the field operator.

In general, embodiments disclosed herein relate to an artificial lift system that includes two pumps, wherein the two pumps may be operated simultaneously using a single power cable from the surface. For example, embodiments disclosed herein provide an artificial lift system comprising two ESPs that are operated using a single power cable extending from the surface. In other embodiments, the artificial lift system may include two progressive cavity pumps (PCPs) that are operated using a single power cable. The two pumps of the artificial lift system may be arranged in series or in parallel to provide the necessary pressure boost. Example embodiments are disclosed below including a dual ESP artificial lift system. However, one of ordinary skill in the art will appreciate that these configuration are equally applicable to other artificial lift devices, such as PCPs.

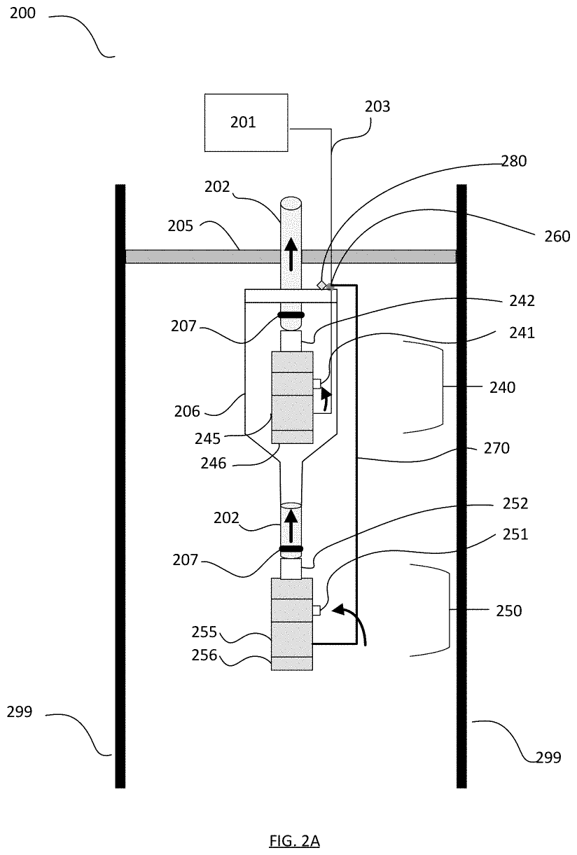

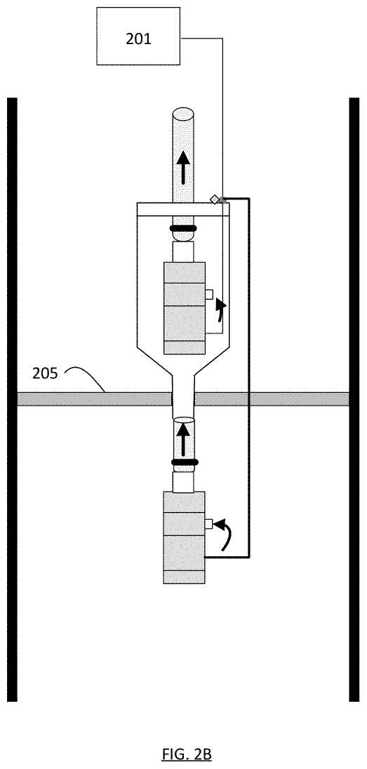

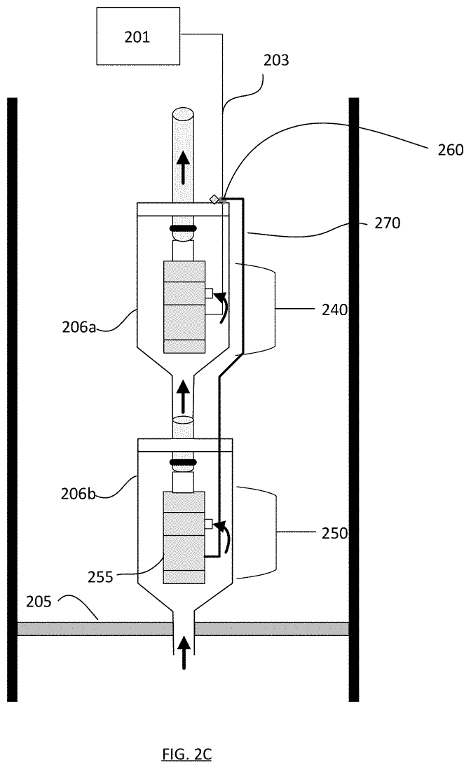

Two configurations of the dual ESP set-up are common: parallel configuration and series configuration. Embodiments having these configurations are described in FIG. 1-2C below.

FIG. 1 shows a pumping system 100 with an upper ESP 140 and a lower ESP 150 connected to a tubing 102 in parallel according to one or more embodiments. The parallel configuration shown may produce a significantly higher flow rate compared to each of the individual ESPs when the ESPs are operated simultaneously. The tubing 102 may extend from deeper in the well to the surface and form a passageway for the extracted oil or gas to be delivered to the surface. The tubing 102 may be surrounded by a casing 199, thereby forming an annulus between the tubing 102 and the casing 199. A packer 105 may be disposed in a horizontal orientation above the ESPs (i.e., above the ESP packer 140) to separate the downhole environment from the uphole environment. One of ordinary skill in the art would understand that, while the tubing 102 is shown to have a hollow cylindrical shape oriented in a vertical direction, it is possible that the tubing 102 is shaped and oriented differently. For example, the tubing 102 may be a combination of multiple tubing components with different dimensions and oriented horizontally or angled with respect to the vertical direction. Further, one of ordinary skill in the art would understand that the terms “upper” and “lower” do not necessarily mean that the two ESPs 140 and 150 are disposed one above the other at different depths such that the ESPs are rotationally aligned about the tubing 102. In one or more embodiments, the ESPs 140 and 150 may be rotationally offset from one another and/or may be positioned at the same depth.

The upper ESP 140 may include a pump inlet 141, a pump outlet 142, a pump body 143, a protector 144, and a motor 145. The motor 145 may further include a sensor 146 such as a monitoring sub/tool. Similarly, the lower ESP 150 may include a pump inlet 151, a pump outlet 152, a pump body 153, a protector 154, and a motor 155. The motor 155 may further include a sensor 156 such as a monitoring sub/tool. One of ordinary skill in the art would understand that the elements shown in the figure are only for the purpose of illustration and do not limit the arrangement or structure of these elements. One of ordinary skill in the art would also understand that other structural or functional elements may also be present in each of ESP 140 and ESP 150. Further, one of ordinary skill in the art would understand that ESP 140 and ESP 150 may have the same structures or may have different structures.

When the upper ESP 140 and the lower ESP 150 are in operation, they generate a pressure difference between inside the pump and outside the pump such that fluids around the upper ESP 140 and the lower ESP 150 may flow inwards into pump bodies 143 and 153 through pump inlets 141 and 151, respectively. The pressure difference may further drive the fluids outwards through pump outlets 142 and 152 which are fluidly coupled to the tubing 102. The general principle of pumping operation is well-known in the art and is not described in detail herein.

As shown in FIG. 1, in configurations where the upper ESP 140 and the lower ESP 150 are fluidly coupled to the tubing in parallel, fluids flow into the pump inlets 141 and 142 independently, without going through the other ESP Likewise, fluids flow out via pump outlets 142 and 152 toward the tubing 102 independently, without going through the other ESP. The flow of the fluids are illustrated using the arrows in FIG. 1 as an example. Note that the pump outlets 142 and 152 may be directly connected to the tubing 102, or may be coupled to the tubing 102 via components such as a Y-tool 147 and 157.

Y-tool 147 and 157 may provide access to bypass the upper ESP 140 and the lower ESP 150 during stimulation and logging, etc. A Y-tool is a component that may be installed on production tubing to provide two separate conduits. A first conduit of the Y-tool is concentric with the tubing 102 and provides access to the reservoir below the ESP, and a second conduit (a bypass leg) of the Y-tool is offset and is coupled to and supports the ESP. To produce well fluid to the surface in this configuration, a plug 158 may be set in the first conduit of the Y-tool 157 of the lower ESP 150. When both ESPs 140 and 150 are turned on, well fluid may flow into the inlet 151 of the lower ESP 150, and the fluid may be pressurized and flow into the Y-tool 157. Because a plug 158 is disposed in the first conduit, the pressurized fluid may flow up the bypass tubing 112. A similar scenario may occur for the upper ESP 140 during production. Since there is higher pressure fluid from the lower ESP 150 flowing up the bypass tubing 112, the pressurized fluid from the upper ESP 140 does not flow down the bypass tubing 112, but instead flows upwards towards the production tubing 122. The combined flows from the ESPs 140 and 150 may commingle just above the Y-tool 147 of the upper ESP 140 and are produced to the surface via the production tubing 122.

Still referring to FIG. 1, the upper ESP 140 and the lower ESP 150 may receive electric power from an uphole power source 101. The electric power may be delivered to the upper ESP 140 via an electric cable 103 which may pass through the packer 105 via a through hole (not shown). Further, the uphole power source 101 may deliver control signals to the upper ESP 140 to control operation parameters, such as ON/OFF of the upper ESP 140 and the speed of the ESP 140, and may receive downhole data measured by the sensor 146.

An electric cable extension 170 may connect the upper ESP 140 and the lower

ESP 150 such that the electric power may be further delivered to the lower ESP 150. Similar to the electric cable 103, the electric cable extension 170 may deliver control signals to the lower ESP 150 and may receive downhole data measured by the sensor 156.

The electric cable 103 and the electric cable extension 170 may be connected by a connector 160 disposed on the first ESP 140. In the example shown in FIG. 1, the connector may be disposed on the motor 145 of the upper ESP 140 such that the electric cable 103 is electrically connected to the motor 145 of the upper ESP. Additionally, the electric cable extension 170 may be electrically connected to the motor 155 of the second ESP 150. The structures of the electric cable extension and the connector are described further below.

Referring now to FIG. 2A, a pumping system 200 with an upper ESP 240 and a lower ESP 250 connected to a tubing 202 in series according to one or more embodiments is shown. Different from the parallel configuration shown in FIG. 1, the fluids in FIG. 2A may first enter the lower ESP 250 via the pump inlet 251. After being pressurized by the lower ESP 250, the fluids may exit the lower ESP 250 via the pump outlet 252 and then enter the upper ESP 240.

An auto flow sub or auto diverter valve 207 may be coupled above the lower ESP 250 (i.e., between the lower ESP 250 and the upper ESP 240) and/or above the upper ESP 240. The valve 207 may be a mechanical opening mechanism that may allow access of fluid either via the tubing 202 or from the tubing casing 299. The valve 207 may operate based on fluid pressure at the lower ESP outlet 252. The valve 207 may include a spring-loaded flapper or sliding sleeve mechanism. In such an embodiment, when an ESP 240, 250 is powered on, pressure of well fluids at the ESP outlet 242, 252 may be high enough to push open the flapper or sliding sleeve mechanism in the valve(s) 207 to allow flow up above the ESP 240, 250 to surface. However, when the ESP 240, 250 is turned off, the flapper or sliding sleeve mechanism of the valve 207 retracts, because no pressure is available to keep the valve 207 open. The valve 207 therefore closes the conduit of the ESP outlet 242, 252 and opens an access to the wellbore annulus to allow fluid to bypass the ESP and flow back down into the well.

In the example shown in FIG. 2A, the upper ESP 240 may be enclosed in a pod 206 that isolates the upper ESP 240 from external downhole environment. The pod 206 may be a housing that is configured to couple to the tubing 202 at an upper end and to tubing and/or the outlet 252 of the lower ESP 250 at a lower end. The series configuration shown in FIG. 2A differs from the parallel configuration shown in FIG. 1 in that the fluids that exit the lower ESP 250 may enter the pod 206 and then be pumped into the upper ESP 240 via the pump inlet 241. After being pressurized again by the upper ESP 240, the fluids may exit the upper ESP 240 via the pump outlet 242 and finally flow to surface via the tubing 202.

As further shown in FIG. 2A, a packer 205 may be installed above the ESPs (i.e., above upper ESP 240) to isolate or separate the downhole environment from the uphole environment. The packer 205 may include a feedthrough (not shown) or through hole to allow a power cable to extend from the surface, sealingly through the packer, and down to the ESPs 240, 250.

Still referring to FIG. 2A, the upper ESP 240 and lower ESP 250 may include similar structure as the ESPs 140, 150 described above with respect to FIG. 1. Specifically, ESPs 240, 250 may include a pump outlet, a pump body, a protector, and a motor. The motor may further include a sensor such as a monitoring sub/tool. Further, the upper ESP 240 and the lower ESP 250 may receive electric power from an uphole power source 201. The electric power may be delivered to the upper ESP 240 via an electric cable 203 which may pass through the packer 205 via a feedthrough (not shown). Further, the uphole power source 201 may deliver control signals to the upper ESP 240 to control operation parameters, such as ON/OFF of the upper ESP 240 and the speed of the ESP 240, and may receive downhole data measured by a sensor 246.

An electric cable extension 270 may connect the upper ESP 240 and the lower ESP 250 such that electric power may be further delivered to the lower ESP 250. Similar to the electric cable 203, the electric cable extension 270 may deliver control signals to the lower ESP 250 and may receive downhole data measured by the sensor 256.

In the example shown in FIG. 2A, the electric cable extension 270 may be electrically connected to the electric cable 203 at a surface of the pod proximate a through hole of the pod. Additionally, the electric cable extension 270 may be electrically connected to the motor 255 of the second ESP 250. In another embodiment, the electric cable 203 and the electric cable extension 270 may be connected by a connector 260 disposed on the first ESP 240. The connector may be disposed on the motor 245 of the upper ESP 240 such that the electric cable 203 is electrically connected to the motor 245 of the upper ESP. In such embodiment, the pod may include a feedthrough or through hole (as shown in FIG. 2A) to allow the electric cable 203 to pass through the pod to the ESP 240, and another feed through or through hole (not shown) to allow cable extension 270 to pass through the pod and electrically connect to motor 255 of the lower ESP 250. The structures of the electric cable extension and the connector are described further below.

FIGS. 2B and 2C show two different variations of series configurations of the pumping system 200 from FIG. 2A according to one or more embodiments. In FIGS. 2B and 2C, numbering is not repeated for elements that are the same as those in FIG. 2A.

As can be seen in FIGS. 2A-2C, FIG. 2B differs from FIG. 2A in that a packer may be disposed between the upper ESP 240 and the lower ESP 250. In other words, the upper ESP 240 in FIG. 2B may be disposed above the packer 205 while the lower ESP 250 remains below the packer 205. Alternatively, the packer 205 may be disposed below both the upper ESP 240 and the lower ESP 250, as shown in FIG. 2C. As can be further seen in FIG. 2C, in some embodiments the lower ESP 250 may also be enclosed in a pod 206 in a similar manner to that discussed above with respect to upper ESP 240. Series configurations as shown in embodiments disclosed herein may provide a high pressure boost of the well fluid for the same flow compared to that of a single ESP. This may be applicable when lifting well fluids from very deep reservoirs.

Apart from the variations shown in FIGS. 2A-2C, there may be other variations with respect to the location of the packer and the use of pods. For example, the packer may be disposed above both ESPs while both ESPs are enclosed in their respective pods. Further, ESPs configured in parallel, as shown in FIG. 1 may also have variations with respect to location of the packer 205 and use of pods 206. For example, in parallel configurations, one or more ESPs may be enclosed in a pod 206, and the packer 205 may be disposed above both ESPs (FIG. 2A), between the two ESPs (FIG. 2B), or below both ESPs (FIG. 2C). In general, the illustrations in FIGS. 1-2C are merely examples of embodiments of the present disclosure and should not limit the scope of the embodiments disclosed.

In one or more of the embodiments disclosed herein, when the upper ESP is enclosed by a pod, the connector that connects the electric cable 203 and/or electric cable extension 270 to one or more ESPs 240, 250 may be disposed on the pod of the upper ESP, instead of on the motor of the upper ESP. Further, as shown in FIG. 2C, the first and second ESPs 240, 250 may be disposed in a first pod 206a and a second pod 206b, respectively. In this embodiment, a connector 260 disposed on the first pod 206a connects the electric cable 203 and the electric cable extension 270. The electric cable extension 270 extends from the connector 260 disposed on the first housing and through the feedthrough or sealed through hole formed in the second pod 206b to the motor 255 of the second ESP 250. Fluid flow through the second pod 206b may be the same as that discussed above with respect to the pod 206 in FIG. 2A

The casing 299, packer 205, tubing 202, and the ESPs 240 and 250 in FIGS. 2A-2C may be substantially the same as those in FIG. 1. Descriptions of these components are thus omitted to avoid redundancy.

When the dual ESPs are configured in series, there may be scenarios where it is desired to impose a delay between the start of the upper ESP 240 and the start of the lower ESP 250. Accordingly, a delay starter 280 may be coupled to the connector 260 to impose the delay. For example, a delay starter 280 may be mounted at the location of the electric cable 203 feedthrough of the pod 206 (FIG. 2A and FIG. 2B) and pod 206a (FIG. 2C) of the upper ESP 240. The structure of the delay starter 280 is discussed below with the reference to FIG. 5.

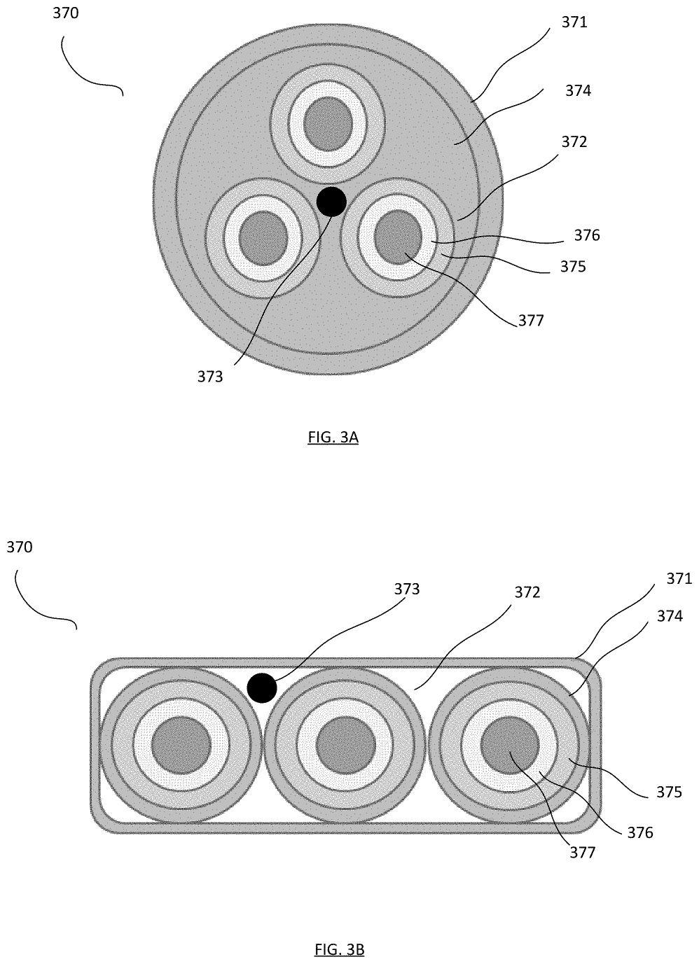

Referring now to FIGS. 3A-3B, each show a cross section of an electric cable extension 370 according to one or more embodiments. The electric cable extensions 170, 270 discussed above may be formed in accordance with the electric cable extension 370 described herein. As shown in these figures, an electric cable 370 may have an external protective layer (“armor”) 371 wrapping around a jacket layer 374. Inside the electric cable 370 there may also be one or more control lines 373 and one or more power lines 372 bundled together. Each power line 372 may have a coaxial structure with multiple layers arranged from external to the internal, namely, a cover 375, an insulator 376, and a conductor 377. While only two examples are shown in FIGS. 3A-3B to illustrate the possible shape and structure of the electric cable extension 370, the scope of the present disclosure should not be limited by these examples. For example, the number of control lines 373 may be greater than one, and the number of power lines 372 may be greater or less than three. The spatial and dimensional relationships between the control line(s) 372 and the power line(s) 373 may also vary.

According to one or more embodiments, voltage may be supplied to both of the ESP motors by the electric power and the power cable extension. Due to the voltage drop along the power extension cable, the voltage reaching the lower ESP motor may be less than that received by the upper ESP motor. To ensure that the voltage at the lower ESP motor is greater than the minimum voltage required to start the motor, a general rule is that the voltage reaching the motor should be at least 50% of the motor nameplate voltage for the motor to start. In practice, proper conductor sizing and soft starters or variable speed frequency controllers may be used to provide low currents during the start of the lower ESP and to reduce the voltage drop along the cable.

While not shown in the figures, the electric cable that runs from the power source may have the same structure and materials as the electric cable extension.

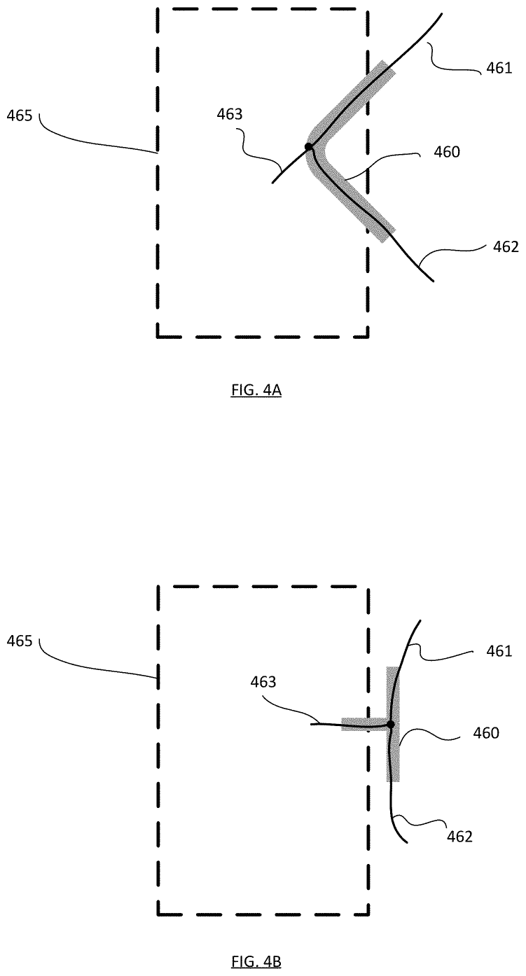

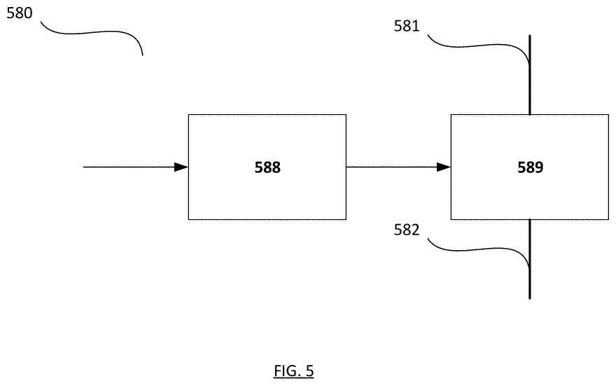

FIGS. 4A-4B each show a shape of a connector 460 according to one or more embodiments. Specifically, the connector 460 in FIG. 4A may have a bifurcated shape while the connector 460 in FIG. 4B may have a trifurcated shape. The connectors 160, 260 discussed above may be formed in accordance with the connector 460 described herein.

In FIG. 4A, the connector 460 may have a shape of “U,” “V”, “L,” or other suitable shapes. The electric cable 461 and the electric cable extension 462 may each enter the connector 460 through one branch of the bifurcated shape, and connect with each other via the connector 460. The connector 460 may be coupled to a body 465 to deliver power and transmit/receive signals to the motor of the upper ESP. A lead 463 may further extend from the connector 460 to connect to the body 465. Body 465 may be a motor head of the upper ESP or may be the pod of the upper ESP, depending on the configuration.

In FIG. 4B, the connector 460 may have a shape of “T,” “Y”, or other suitable shapes. The electric cable 461 and the electric cable extension 462 may each enter the connector 460 through one branch of the trifurcated shape, and connect with each other via the connector 460. A lead 463 may further extend from the third branch of the trifurcated shape to connect to the body 465.

By using the connector and the electric cable extension, electric power and control signals may be delivered to the lower ESP via the electric cable and the electric cable extension. Likewise, downhole data measured by, e.g., the sensor may be transmitted uphole via the electric cable extension and the electric cable.

Factors to consider in selecting the design and/or configuration of the structure of the connector may include the following: toughness and rigidity of the connector to prevent the connection between the electric cable and the cable extension from breaking down, because the connector is close to a connection point of the electric and the electric cable extension; minimum bending of the electric cable at the connection point to reduce stresses; erosion and abrasion resistant surface to ensure structural integrity; resistance to chemical, mechanical attacks from wellbore liquids and gases such as H2S and CO2; sealing capabilities around the electric cable and the cable extension to prevent ingress of wellbore fluids into the motor; and overall protection of the electrical and mechanical integrity of the cable connections.

FIG. 5 shows a block diagram of a delay starter 580 according to one or more embodiments. The delay starter 580 may include a control circuit 588 and a power switch 589. The control circuit 588 may receive and process control signals either from surface or from sensors installed downhole (e.g., current and voltage sensors or motor status sensors). The control circuit 588 may further control the power switch 589 to switch the flow of current between ON/OFF. The control circuit 588 may also control the operation speed of the motor or one or more ESPs.

The power switch 589 may be connected to the electric cable 581 and/or the electric cable extension 582. The power switch 589 may be a mechanical switch. For example, the power switch 589 may include copper that contacts with an electromechanical actuator. The power switch 589 may also be an electronic switch. For example, the power switch 589 may be a solid state power electronics such as a silicon controlled rectifier. The power switch 589 may also be a metal-oxide-semiconductor field-effect transistor (MOSFET) or any other suitable electronic component. An electronic power switch 589 may provide soft start to the motor to reduce the voltage drop in the system.

The delay starter 580 may be controlled from the surface to impose the delay. In this case, there may be a signal from the surface that expressly instructs the delay starter to switch the lower motor on after the upper motor has started. Alternatively, the delay starter 580 may operate in an automatic mode based on the sensed downhole data and a pre-programmed amount of delay. In this mode, once the delay starter determines it is time to start, e.g., the lower ESP, the control circuit 588 sends a signal to the power switch to allow electric current to flow to the lower ESP.

As discussed above, the present disclosure provides a pumping system with dual ESPs operating simultaneously without two separate power cables to drive both the upper ESP and the lower ESP. In other words, a pumping system in accordance with embodiments disclosed herein drives dual ESPs simultaneously with a single power cable extending from the surface. The cost and complexity of a pumping system in accordance with embodiments disclosed herein may, therefore, advantageously be reduced. Further, with the reduction of the number of cables running from the power source to downhole, the number of splices above or below the packer may be reduced. This may advantageously result in a lesser susceptibility of ESP failure due to electrical failure at the splice caused by concentrated corrosive gas that accumulates just under the packer

While the disclosure has been described with respect to a limited number of embodiments, those skilled in the art, having benefit of this disclosure, will appreciate that other embodiments can be devised which do not depart from the scope of the disclosure. Accordingly, the scope of the disclosure should be limited only by the attached claims.

1. A pumping system for pumping downhole fluid, comprising:
a first electric submersible pump (ESP) and a second ESP, each of the first ESP and the second ESP comprising a motor, a pump inlet, and a pump outlet;
a tubing fluidly coupled to the pump outlet of the first ESP and the pump outlet of the second ESP;
a connector coupled to the first ESP;
an electric cable coupled between an uphole power source and the connector to deliver electric power to the motor of the first ESP; and
an electric cable extension coupled between the connector and the second ESP to deliver electric power to the motor of the second ESP,
wherein the first ESP and the second ESP are fluidly coupled to the tubing in parallel such that the downhole fluid independently enters and exits the first ESP and the second ESP, and
wherein the electrical cable and the electric cable extension simultaneously control the first ESP and the second ESP.

2. The pumping system according to claim 1, wherein the electric cable is electrically connected to the motor of the first ESP, and the electric cable extension is electrically connected to the motor of the second ESP.

3. The pumping system according to claim 1,
wherein at least one of the motor of the first ESP and the motor of the second ESP comprises a sensor that measures downhole data, and
wherein the sensor transmits the measured downhole data uphole via the electric cable or the electric cable extension.

4. The pumping system according to claim 1, wherein the connector has a bifurcated shape.

5. The pumping system according to claim 1, wherein the connector has a trifurcated shape.

6. The pumping system according to claim 1,
further comprising a delay starter coupled to the connector, the delay starter comprising a control circuit and a power switch,
wherein the control circuit turns the power switch between ON and OFF based on an uphole control signal transmitted by the uphole power source or based on the downhole data transmitted by the sensor, and
wherein the motor of the second ESP is turned ON when the power switch is turned ON, and the motor of the second ESP is turned OFF when the power switch is turned OFF.

7. The pumping system according to claim 6,
wherein the control circuit controls an operation speed of the motor of the second ESP based on the uphole control signal.

8. The pumping system according to claim 6, wherein the control circuit imposes a delay between a start of the motor of the first ESP and a start of the motor of the second ESP.

9. The downhole pumping system according to claim 1,
wherein the electric cable extension comprises a control line and a power line,
wherein the control line and the power line are bundled inside a protective layer.

10. A pumping system for pumping downhole fluid, comprising:
a first electric submersible pump (ESP) and a second ESP, each of the first ESP and the second ESP comprising a motor, a pump inlet, and a pump outlet;
a tubing fluidly coupled to the pump outlet of the first ESP and the pump outlet of the second ESP;
a connector coupled to the first ESP;
an electric cable coupled between an uphole power source and the connector to deliver electric power to the motor of the first ESP; and
an electric cable extension coupled between the connector and the second ESP to deliver electric power to the motor of the second ESP,
wherein the first ESP and the second ESP are fluidly coupled to the tubing in series such that the pump outlet of the second ESP is in fluid communication with the pump inlet of the first ESP, and
wherein the electrical cable and the electric cable extension simultaneously control the first ESP and the second ESP.

11. The pumping system according to claim 10, wherein the electric cable is electrically connected to the motor of the first ESP, and the electric cable extension is electrically connected to the motor of the second ESP.

12. The pumping system according to claim 10,
wherein the electric cable provides a conduit to transmit a control signal from the uphole power source to the first ESP, and the electric cable extension provides a conduit to transmit the control signal further to the second ESP.

13. The pumping system according to claim 10,
wherein at least one of the motor of the first ESP and the motor of the second ESP comprises a sensor that measures downhole data, and
wherein the sensor transmits the measured downhole data uphole via the electric cable or the electric cable extension.

14. The pumping system according to claim 10, wherein the connector has a bifurcated shape.

15. The pumping system according to claim 10, wherein the connector has a trifurcated shape.

16. The pumping system according to claim 10, further comprising a first housing,
wherein the first ESP is enclosed in the first housing, and
wherein the connector is disposed on the first housing.

17. The pumping system according to claim 16, further comprising a second housing,
wherein the second ESP is enclosed in the second housing, and
wherein the electric cable extension extends from the connector disposed on the first housing through a feedthrough in the second housing to the motor of the second ESP.

18. The pumping system according to claim 12,
further comprising a delay starter coupled to the connector, the delay starter comprising a control circuit and a power switch,
wherein the control circuit turns the power switch between ON and OFF based on the control signal or the downhole data, and
wherein the motor of the second ESP is turned ON when the power switch is turned ON, and the motor of the second ESP is turned OFF when the power switch is turned OFF.

19. The pumping system according to claim 18,
wherein the control circuit controls an operation speed of the motor of the second ESP based on the control signal, and wherein the control circuit imposes a delay between a start of the motor of the first ESP and a start of the motor of the second ESP.

20. The downhole pumping system according to claim 10,
wherein the electric cable extension comprises a control line and a power line,
wherein the control line and the power line are bundled inside a protective layer.
